(19) United States
(12) Patent Application Publication
(10) Pub. No.: US 2022/0394427 A1
(43) Pub. Date: Dec. 8, 2022

(54) bEiN

(71) Applicant: Stanley Crowell, East Orange, NJ (US)

(72) Inventor: Stanley Crowell, East Orange, NJ (US)

(21) Appl. No.: 17/338,170

(22) Filed: Jun. 3, 2021

(51) Int. Cl. H04W 4/029

(52) U.S. Cl. CPC H04W 4/029

(57) ABSTRACT

To have a digital State/Driver License With Fingerprints appearing on the face Of State/Driver License and Digital License Plate where it can be Connected To a Network for logging and locating Every movement. With the fingerprints There woul be any duplicate identity. It would protect the way of Voting only One individual w receive a ballot and With the equipment you'll have to use a Fingerprint. Save a Ic time not having To present six forms of ID. A police stop When no ID present just the fingerprint And individual is identify. Be able to vote At the leisure of your own home with Your ID number. Help with a love missing or Domestic violence by using App to Locate an individual every movement And Other digital device is located.

### FIELD

The Network here is to enhance the way People are being protected and quicker Respond time for wanting a better way of Being somewhat protected.

### BACKGROUND

With this enhancement to assure someone That they have a better way of being Responded with Authority. Not only for Humans being trace also Vehicles and Devices in the Network. There's of ways To distinguish the difference type of Emergency from Elderly can't get up or Having having health is sue. They have Issues of a Love one drift off and can't be Found this enhancement be able to Locate and log their every movement. With the enhanced Network it will not be Any duplicate identity you'll be able to Distinguish every body with one full Proof procedure. No more forging any Voting.

### SUMMARY

This Network would make a impact on Society by putting people to work. Having The capability to use a voice command to Activate the Network. For the future add A necklace or wrist band to activate the Network for an emergency. There's a Procedure that would eliminate confusion. There would be a different way of policing Society in all States. This is very for the Much Young and the Elderly.

### BRIEF DESCRIPTION OF THE PHOTOS

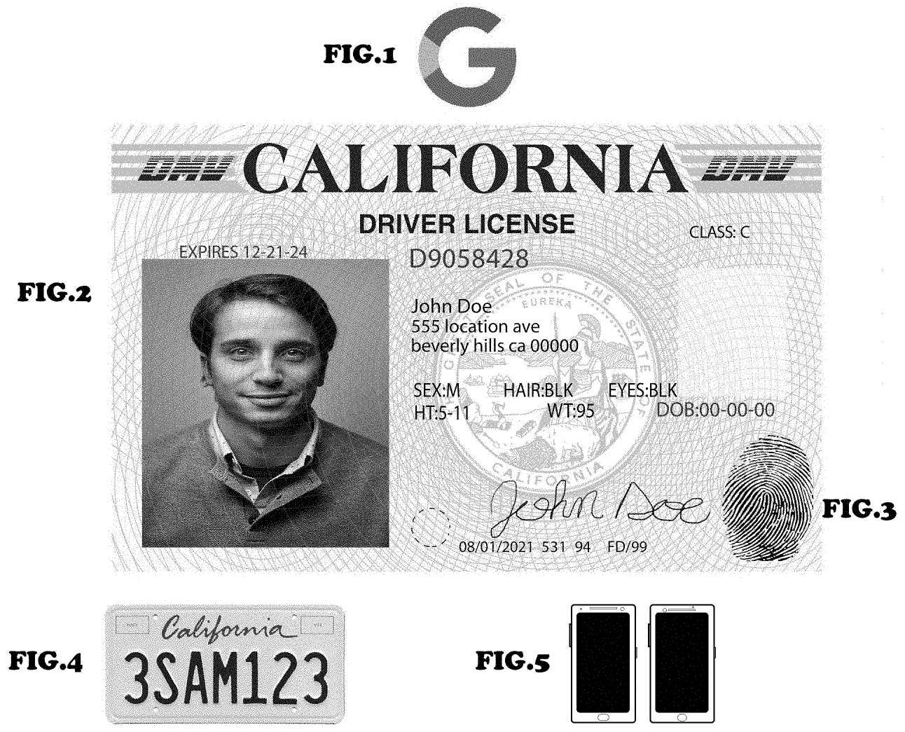

FIG. 1 Thru FIG. 5 Is a view of the requirement to Complete the Network.

### DETAILED DESCRIPTION

Cellular phones would be the initial setup In the Network by creating an App that has Multiple sources by using a menu of Various selections of the severity of an Emergency.

A voice command to to Activate the cell to start audio and video. Google would have Many Options to track Movement and .log every component with In the Network. You'll be able to ping an IP address to each component on the Network. DMV/MVC Has State/Driver License ID and License Plates also see What's in vicinity when Logging and Tracing components. Fingerprints has a Protecting of only one person Associated With the State and Driver License ID. License Plates has an assign Person That's connected to the Registration from DMV/MVC Department.

1. FIG. 1 To use Google to locate a digital Device that connected in the Network for Locating and monitoring Every digital Movement.
FIG. 2 Digital State and Driver License That's identifying an individual in the Network. Their location and Movement.
FIG. 3 Fingerprint that has an unique print That can't be duplicated and help out for The Voting process. FIG. 4 Digital License Plate to locate every Movement excellent for Amber Alert.
FIG. 5 All Cellular phones that has excess To an App to respond to the Serenity of a Giving situation. Once Selected it activate Video and Audio.
